(19) United States
(12) Patent Application Publication
(10) Pub. No.: US 2013/0307469 A1
(43) Pub. Date: Nov. 21, 2013

(54) CONTACTLESS POWER SUPPLY SYSTEM AND POWER TRANSMISSION COIL FOR CONTACTLESS POWER SUPPLY SYSTEM

(71) Applicant: SUMIDA CORPORATION, Tokyo (JP)

(72) Inventors: Morihiro KURODA, Tokyo (JP); Syuichi KIKUCHI, Tokyo (JP)

(73) Assignee: SUMIDA CORPORATION, Tokyo (JP)

(21) Appl. No.: 13/790,454

(22) Filed: Mar. 8, 2013

(30) Foreign Application Priority Data
May 15, 2012 (JP) 2012-111876
Sep. 13, 2012 (JP) 2012-201673

(51) Int. Cl. H04B 5/00; H02J 7/02

(52) U.S. Cl. CPC H04B 5/0037; H02J 7/025
USPC 320/108; 307/104

(57) ABSTRACT

A contactless power supply system includes a power transmission coil, a power receiving coil, and a center tap that is provided at the power transmission coil. Specifically, the power transmission coil has a first coil and a second coil. The first coil is configured with a first conducting wire that circularly extends from the center tap by winding in a first direction from a first internal circumference side to a first external circumference side. The second coil is configured with a second conducting wire that circularly extends from the center tap by winding in a second direction, which is opposite to the first direction, from a second internal circumference side to a second external circumference side. A first number of windings of the first coil is approximately the same as a second number of windings of the second coil.

### CROSS-REFERENCE TO RELATED APPLICATION

This application claims priority to Japanese Patent Application No. 2012-111876 filed May 15, 2012 and Japanese Patent Application No. 2012-201673 filed Sep. 13, 2012 which are hereby expressly incorporated by reference herein in their entirety.

### BACKGROUND

The present invention relates to a contactless power supply system and a power transmission coil for a contactless power supply system.

When power is transmitted without direct electrical connection or physical contact (i.e., contactless power supply), it is necessary for a power receiving coil to be accurately located at a specific position relative to a power transmission coil to supply electric power with high efficiency. Japanese Patent Publication No. 2011-250632 discloses a contactless power supply device. The disclosed contactless power supply device includes a moving mechanism that moves or rotates a power transmission device and a power receiving device relative to each other to easily supply electric power with high efficiency. In the disclosed contactless power supply device, a power transmission coil and a power receiving coil are magnetically coupled to each other at a specific position to which the power transmission device or the power receiving device is moved. Further, in the disclosed contactless power supply device, the power receiving coil can be recognized by a relatively simple configuration and can be fixed to the specific position.

A device (e.g., a battery charger) in which the power transmission coil is installed has a circuit that converts an alternating current (AC) voltage of an AC power source into a direct current (DC) voltage and that applies a high frequency voltage to the power transmission coil. To reduce the number of transistors that are used in the circuit of the battery charger, however, it would be preferred to adopt a push-pull method.

In view of the above, an object of the present invention is to provide a contactless power supply system that can transmit power without direct electrical connection or physical contact by using a push-pull circuit and a power transmission coil for a contactless power supply system.

### SUMMARY

To address the above problems, a contactless power supply system according to an aspect of the present invention includes a power transmission coil, a power receiving coil, and a center tap that is provided at the power transmission coil.

In a contactless power supply system according to a first aspect of the present invention, the transmission coil has a first coil and a second coil. The first coil is configured with a first conducting wire that circularly extends from the center tap by winding in a first direction from a first internal circumference side to a first external circumference side. The second coil is configured with a second conducting wire that circularly extends from the center tap by winding in a second direction, which is opposite to the first direction, from a second internal circumference side to a second external circumference side. Further, a first number of windings of the first coil is approximately the same as a second number of windings of the second coil. A first length and a first thickness of the first conducting wire are approximately the same as a second length and a second thickness of the second conducting wire, respectively.

In a contactless power supply system according to a second aspect of the present invention, the transmission coil has a first coil and a second coil. The first coil is configured with a first conducting wire that circularly extends from the center tap by winding in a first direction from a first external circumference side to a first internal circumference side. The second coil is configured with a second conducting wire that circularly extends from the center tap by winding in a second direction, which is opposite to the first direction, from a second external circumference side to a second internal circumference side. Further, a first number of windings of the first coil is approximately the same as a second number of windings of the second coil. A first length and a first thickness of the first conducting wire are approximately the same as a second length and a second thickness of the second conducting wire, respectively.

In a contactless power supply system according to another aspect of the present invention, the first coil and the second coil are substantially located in the same plane.

A contactless power supply system according to another aspect of the present invention further includes a portable electronic device and a charger. The power receiving coil is mounted in the portable electronic device. The power transmission coil is mounted in the charger.

In a contactless power supply system according to another aspect of the present invention, the first wire and the second wire are litz wires.

In a contactless power supply system according to another aspect of the present invention, each litz wire has a plurality of first strands and a plurality of second strands that are intertwined with each other in a spiral. A diameter of each of the plurality of first strands is larger than a diameter of each of the plurality of second strands. A high frequency electric power between 50 kHz and 500 kHz is supplied through the litz wires

In a contactless power supply system according to another aspect of the present invention, a ratio of the first strands to the second strands is equal to or more than 0.4 and equal to or less than 1.0.

In a contactless power supply system according to another aspect of the present invention, a ratio of a cross section area of one of the plurality of first strands to a cross section area of one of the plurality of second strands is equal to or more than 0.01 and equal to or less than 0.25.

In a contactless power supply system according to another aspect of the present invention, a ratio of a sum of cross sections of the plurality of first strands to a sum of cross sections of the plurality of second strands is equal to or more than 0.004 and equal to or less than 0.25.

A transmission coil of a contactless power supply system according to an aspect of the present invention includes a litz wire that has a plurality of strands and a center tap that is provided at the litz wire.

An effect of the present invention is to provide a contactless power supply system that can transmit power without direct electrical connection or physical contact by using a push-pull circuit and a power transmission coil for the contactless power supply system.

### BRIEF DESCRIPTION OF THE DRAWINGS

FIG. 1 is a schematic view that shows a configuration of a contactless power supply system according to an embodiment of the present invention.

FIGS. 2A and 2B are schematic views that show an embodiment of a power transmission coil shown in FIG. 1. Specifically, FIG. 2A is a schematic view that shows an external appearance of the power transmission coil. FIG. 2B is a plan view that shows a winding direction and a winding condition of a conducting wire that configures the power transmission coil.

FIGS. 3A through 3C are schematic views that show other embodiments of the power transmission coil shown in FIG. 1. Specifically, FIG. 3A is a schematic view that shows an external appearance of the power transmission coil. FIGS. 3B and 3C are plan views that show a winding direction and a winding condition of a conducting wire that configures the power transmission coil.

FIG. 4 is a schematic view that shows an embodiment of a configuration of a tap wire (a center tap).

FIG. 5 is a schematic view that shows another embodiment of a configuration of a tap wire (a center tap).

FIG. 6 is a schematic view that shows yet another embodiment of a configuration of a tap wire (a center tap).

FIG. 7 is a sectional view that shows an embodiment of a cross section taken along line A-A of the power transmission coil shown in FIG. 3A.

FIGS. 8A and 8B are schematic views that show a modification of the power transmission coil shown in FIGS. 3A and 7. Specifically, FIG. 8A is a plan view of a power transmission coil. FIG. 8B is a sectional view of the power transmission coil taken along line B-B in FIG. 8A.

FIG. 9 is a schematic view that shows another modification of the power transmission coil shown in FIGS. 3A and 7.

FIG. 10 is a plan view that shows a modification of the power transmission coil shown in FIG. 8A.

FIG. 11 is a schematic view that shows an embodiment of a configuration of a litz wire.

FIG. 12 is an enlarged perspective view that shows a condition in which the litz wire shown in FIG. 11 is extended.

FIG. 13 is a schematic view that shows another embodiment of a configuration of the litz wire shown in FIG. 12.

### DESCRIPTION OF EXEMPLARY EMBODIMENT

A contactless power supply system according to an embodiment of the present invention has a power transmission coil and a power receiving coil. Further, the power transmission coil has a center tap. Therefore, a push-pull method, in which the number of transistors in a circuit connecting to the power transmission coil decreases, can be adopted as compared with a conventional contactless power supply system that uses a power transmission coil that does not have a center tap.

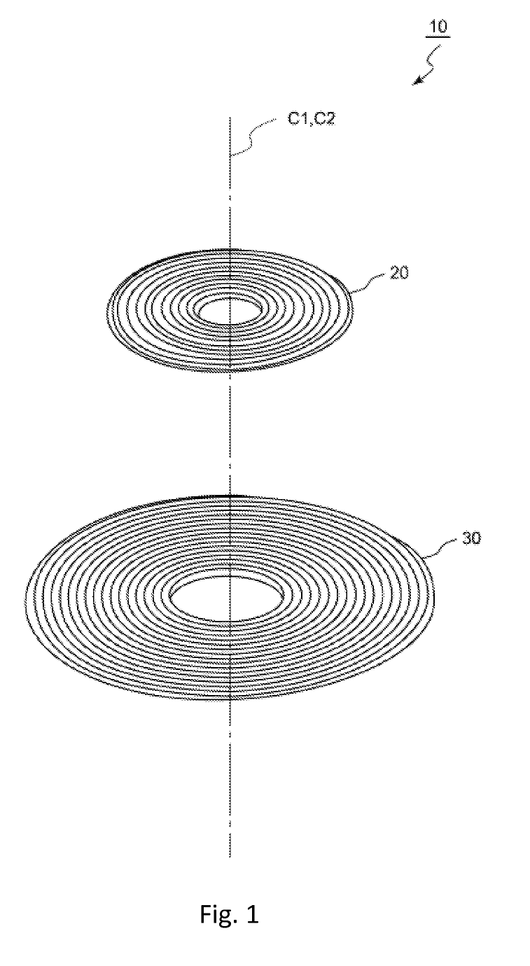

FIG. 1 is a schematic view that shows a configuration of a contactless power supply system 10 according to an embodiment of the present invention. In FIG. 1, a circuit, which is connected to a power receiving coil 20 and a power transmission coil 30, and a center tap, which is provided with the power transmission coil, are omitted. The contactless power supply system 10 according to the embodiment of the present invention shown in FIG. 1 includes the power receiving coil 20 and the power transmission coil 30. To increase the efficiency of electric power supply without direct electrical connection or physical contact, the position of the power receiving coil 20 and the power transmission coil 30 are adjusted relative to each other so as to match a central axis C1 of the power receiving coil 20 with a central axis C2 of the power transmission coil 30 as accurately as possible. Further, according to the embodiment shown in FIG. 1, the central axis C1 of the power receiving coil 20 and the central axis C2 of the power transmission coil 30 are in line with each other. However, when the efficiency of electric power supply does not need to be high, it is not necessary that the positions of the central axes C1 and C2 are aligned with each other. They can be moderately shifted.

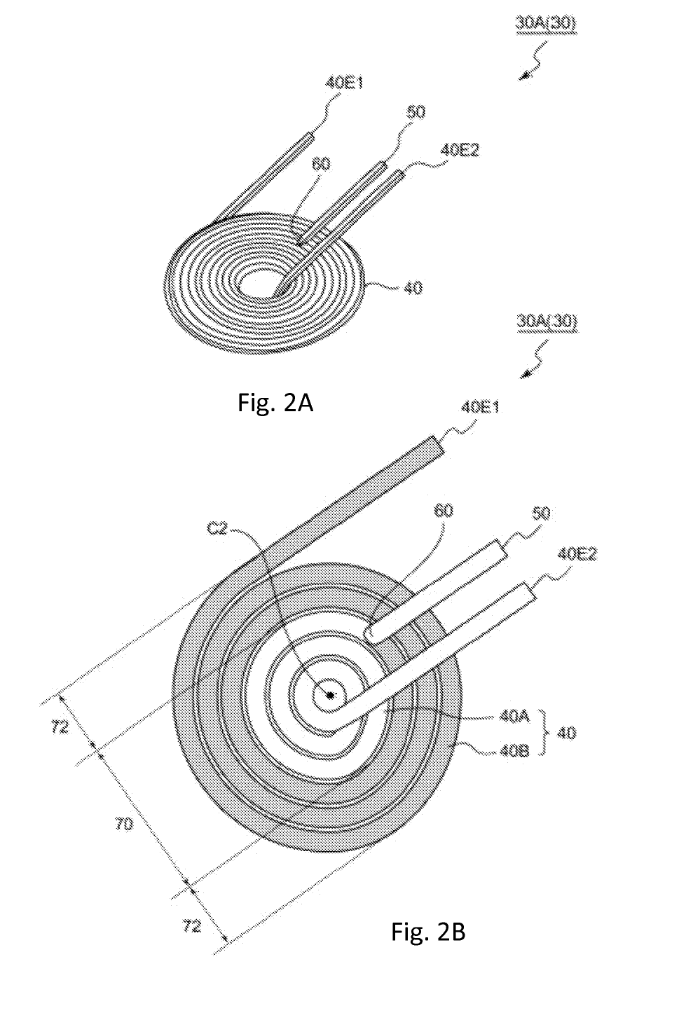

FIGS. 2A and 2B are schematic views that show the embodiment of the power transmission coil 30 shown in FIG. 1. Specifically, FIG. 2A is the schematic view that shows an external appearance of the power transmission coil 30A (30). FIG. 2B is a plan view that shows a winding direction and a winding condition of a conducting wire 40 that configures the power transmission coil 30A. In FIG. 2B, the number of windings is reduced because a winding direction and a winding condition of the conducting wire 40 are easily explained. The power transmission coil 30A (30) shown in FIGS. 2A and 2B is formed by winding the conducting wire 40 from an internal circumference side to an external circumference side. Further, a tap wire 50 (a center tap) is attached near the middle point between one wire end 40E2 and another wire end 40E1. Specifically, the power transmission coil 30A (30) has the wire end 40E2 that is located at the internal circumference side of the conducting wire 40 and the wire end 40E1 that is located at the external circumference side of the conducting wire 40. Therefore, the power transmission coil 30A (30) includes an internal circumference side coil 70 and an external circumference side coil 72. Specifically, the internal circumference side coil 70 is configured with a part between the wire end 40E2 and a node 60 to which the tap wire 50 is connected of the conducting wire 40. The internal circumference side coil 70 corresponds to a conducting wire 40A (a part of the conducting wire 40 that is shown against a gray colored background in FIG. 2B). Further, the external circumference side coil 72 is configured with a part between the node 60 and the wire end 40E1. The external circumference side coil 72 corresponds to a conducting wire 40B (a part of the conducting wire 40 that is colored in gray in FIG. 2B).

However, in the power transmission coil 30A shown in FIG. 2, there are some problems as discussed next. It is difficult to keep a balance of self-inductances between the internal circumference side coil and the external circumference side coil 72 in the push-pull method. Further, it is difficult to keep a balance of a coupling coefficient between the internal circumference side coil 70 and the power receiving coil and a coupling coefficient between the external circumference side coil 72 and the power receiving coil 20. In addition, when a position deviation occurs between the central axis C1 of the power receiving coil and the central axis C2 of the power transmission coil 30A, the coupling coefficients tend to be different between the internal circumference side coil 70 and the power receiving coil 20 and between the external circumference side coil 72 and the power receiving coil 20.

For example, the tap wire 50 is attached at a position where the number of windings of the conducting wire 40 that configures the power transmission coil 30A is divided in two. At the same time, the central axis C1 of the power receiving coil 20 and the central axis C2 of the power transmission coil 30 are in line with each other as shown in FIG. 1. In this case, a coupling coefficient between the internal circumference side coil and the power receiving coil 20 is 0.344. On the other hand, a coupling coefficient between the external circumference side coil 72 and the power receiving coil is 0.163. As a result, there is a big difference between the coupling coefficient between the internal circumference side coil 70 and the power receiving coil and the coupling coefficient between the external circumference side coil 72 and the power receiving coil 20.

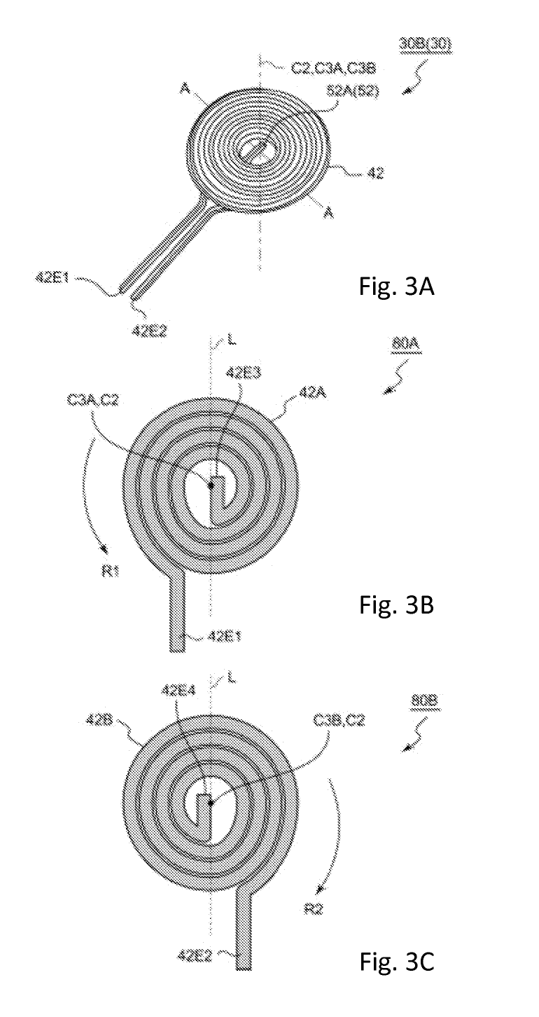

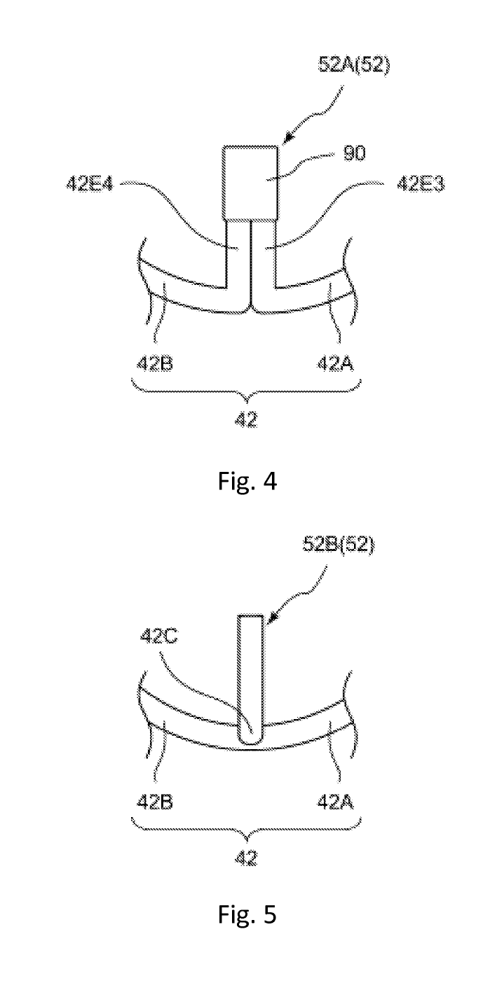

In order to suppress the issues discussed above, it is preferred that a coil that has a configuration shown in FIGS. 3 and 4 is used for a power transmission coil 30B (30).

FIGS. 3A through 3C are schematic views that show other embodiments of the power transmission coil 30 shown in FIG. 1. Specifically, FIG. 3A is a schematic view that shows an external appearance of the power transmission coil 30B (30). FIGS. 3B and 3C are plan views that show a winding direction and a winding condition of a conducting wire 42 that configures the power transmission coil 30B. FIG. 3B is a plan view that shows a first coil 80A. FIG. 3C is a plan view that shows a second coil 80B. Further, in FIGS. 3B and 3C, the number of windings is reduced because a winding direction and a winding condition of the conducting wire 42 are easily explained.

The power transmission coil 30B shown in FIG. 3A is configured by winding the conducting wire 42. Further, the power transmission coil 30B shown in FIG. 3A has a tap wire (a center tap) 52A (52) that is located at an internal circumference side thereof and wire ends 42E1 and 42E2 of the conducting wire 42 that are located at an external circumference side. Further, the power transmission coil 30B has the first coil 80A and the second coil 80B. Specifically, the first coil 80A is configured with a conducting wire 42A that is a part of the conducting wire 42. The second coil 80B is configured with a conducting wire 42B that is the rest of the conducting wire 42.

The tap wire 52A (52) shown in FIG. 3A corresponds to a wire end 42E3 and its adjacent part of the conducting wire 42A shown in FIG. 3B. Similarly, the tap wire 52A (52) shown in FIG. 3A corresponds to a wire end 42E4 and its adjacent part of the conducting wire 42B shown in FIG. 3C. When the tap wire 52A is a winding start point, the first coil 80A is configured with the conducting wire 42A that is circularly extending from the tap wire 52A by winding in a winding direction R1 (counter clockwise rotation direction shown in FIG. 3B) from an internal circumference side to an external circumference side. Similarly, when the tap wire 52A is a winding start point, the second coil 80B is configured with the conducting wire 42B that is circularly extending from the tap wire 52A by winding in a direction R2 (clockwise rotation direction shown in FIG. 3C) from the internal circumference side to the external circumference side. Note that a first number of windings of the first coil 80A is approximately the same as a second number of windings of the second coil 80B. A first length and a first thickness of the conducting wire 42A (for the first coil 80A) are approximately the same as a second length and a second thickness of the conducting wire 42B (for the second coil 80B), respectively.

Namely, the first coil 80A is substantially the same as the second coil 80B except the winding directions R1, R2 of the conducting wires 42A and 42B, which configure the first coil 80A and the second coil 80B. As shown in FIGS. 3B and 3C, the winding directions R1, R2 are different. Therefore, in the power transmission coil 30B shown in FIGS. 3A-3C, it is extremely easy to balance self-inductances between the first coil 80A and the second coil 80B in the push-pull method. Further, it is also extremely easy to balance a coupling coefficient between the first coil 80A and the power receiving coil 20 and a coupling coefficient between the second coil 80B and the power receiving coil 20. In addition, when a position deviation occurs between the central axis C1 of the power receiving coil and the central axis C2 of the power transmission coil 30B, it is possible to prevent coupling coefficients from occurring between the first coil 80A and the power receiving coil 20 and between the second coil 80B and the power receiving coil 20.

For example, when the central axis C1 of the power receiving coil 20 and the central axis C2 of the power transmission coil 30 (30B) are in line with each other as shown in FIG. 1, a central axis C3A (C2) of the first coil 80A and a central axis C3B (C2) of the second coil 80B coincide with the central axis C1 of the power receiving coil 20. In this case, a coupling coefficient between the first coil 80A and the power receiving coil 20 is 0.222. On the other hand, a coupling coefficient between the second coil 80B and the power receiving coil 20 is 0.208.

Therefore, as compared with the contactless power supply system 10 (refer to FIG. 1) that uses the power transmission coil 30A according to the embodiment of the present invention shown in FIG. 2, the contactless power supply system 10 that uses the power transmission coil 30B according to the above embodiment of the present invention shown in FIG. 3A can prevent a situation in which the contactless power supply system is not working correctly from occurring. This situation is caused by an increase of coupling coefficient variation between coils. A load variation is caused by the position deviation between the central axis C1 of the power receiving coil 20 and the central axis C2 of the power transmission coil 30. Even though the load variation occurs, the first and second coils 80A and 80B, which configure the power transmission coil 30B, vary in the same manner. Therefore, a negative influence to a driving circuit that is connected to the power transmission coil 30B can be prevented from occurring.

Further, in the embodiment shown in FIGS. 3A through 3C, the central axis C3A of the first coil 80A and the central axis C3B of the second coil 80B are completely in line with each other. In other words, the central axis C2 of the power transmission coil 30B is co-linear with the central axis C3A and the central axis C3B. However, it is not necessary that the central axis C3A of the first coil 80A and the central axis C3B of the second coil 80B be completely in line with each other. It is desired, however, that the central axis C3A of the first coil 80A and the central axis C3B of the second coil 80B be approximately in line with each other. Further, with respect to manufacture of the power transmission coil 30B, the first coil 80A can be formed by winding the conducting wire 42 either from the internal circumference side to the external circumference side or from the external circumference side to the internal circumference side. In this respect, the second coil 80B can be formed in the same manufacturing manner. Yet further, the power transmission coil 30 that uses the first coil 80A and the second coil 80B according to other embodiments can be formed in the same manufacturing manner. However, in general, it is preferred that the first and second coils 80A and 80B are formed by winding the conducting wire 42 from the internal circumference side to the external circumference side by a coil winding machine or a manual operation by using a winding axis.

According to the embodiment shown in FIGS. 3A through 3C, the planes of the first coil 80A and the second coil 80B are orthogonal to the central axis C2. At the same time, the first coil 80A and the second coil 80B are approximately line symmetric with respect to a line L that is parallel to extension lines of wire ends 42E1, 42E3, 42E2 and 42E4. However, the configuration of the first and second coils 80A and 80B are not limited to the above configuration. They can also be non-axially symmetric. When the first coil 80A and the second coil 80B are approximately axially symmetric to the line L, it is easy to balance self-inductances between the first coil 80A and the second coil 80B. Further, it is also easy to balance a coupling coefficient between the first coil 80A and the power receiving coil 20 and a coupling coefficient between the second coil 80B and the power receiving coil 20.

According to the embodiment of the present invention shown in FIG. 3A, in the power transmission coil 30B, the tap wire 52A (52) is formed by bunching the wire ends 42E3 and 42E4 together and fixing them in order not to separate from each other as shown in FIG. 4. For instance, in the tap wire 52A (52) shown in FIG. 4, the tips of the wire ends 42E3 and 42E4, which are bunched together, are covered with a tubular end 90. Subsequently, the tubular end 90 is crimped from both sides of a circumference surface of the tubular end 90 toward the bunched wire ends 42E3 and 42E4 to fix the wire ends 42E3 and 42E4 together. Therefore, it is possible to prevent the wire ends 42E3 and 42E4 from easily separating. Further, the fixing method for the wire ends 42E3 and 42E4 is not limited to the above. For example, solder may be used instead of the tubular terminal 90 to fix the wire ends 42E3 and 42E4. The tips of the wire ends 42E3 and 42E4 may also be fixed by twisting and interwinding with each other. That is, there is no limit to be taken as a method to fix the wire ends 42E3 and 42E4. The method for using the tubular end 90 shown in FIG. 4, the method for using the solder, the method for twisting and interwinding with the wire ends 42E3 and 42E4, and combinations of methods that are selected from the above and other methods for fixing the wire ends 42E3 and 42E4 can be used.

Further, when the tap wire 52A shown in FIG. 4 is formed, the wire end 42E3 of the conducting wire 42A that configures the first coil 80A is bent toward an internal circumference side so as to substantially perpendicular to the winding direction R1 of the conducting wire 42A as shown in FIG. 3B. Similarly, the wire end 42E4 of the conducting wire 42B that configures the second coil 80B is bent toward the internal circumference side so as to be substantially perpendicular to the winding direction R2 of the conducting wire 42B as shown in FIG. 3C.

Further, according to the embodiment of the present invention shown in FIGS. 3A-3C and 4, the conducting wire 42 is configured with the two conducting wires that correspond to the conducting wires 42A and 42B that are physically separated from each other. However, the conducting wire 42 is not limited to this configuration. The conducting wire 42 may be configured with one conducting wire that is continuously connected between the conducting wires 42A and 42B.

In this case, as shown in FIG. 5, a tap wire 52B (52) can be connected to an approximate intermediate point 42C between the wire end 42E1 (not shown in FIG. 5) and the wire end 42E2 (not shown in FIG. 5) of the conducting wire 42. In this case, a part between the approximate intermediate point 42C and the wire end 42E1 configures the conducting wire 42A. Further, a part between the approximate intermediate point 42C and the wire end 42E2 configures the conducting wire 42B. Further, in this case, the tap wire 52B can be attached to the approximate intermediate point 42C of the conducting wire 42 by soldering or by winding and interwinding one end of the tap wire 52B with the conducting wire 42.

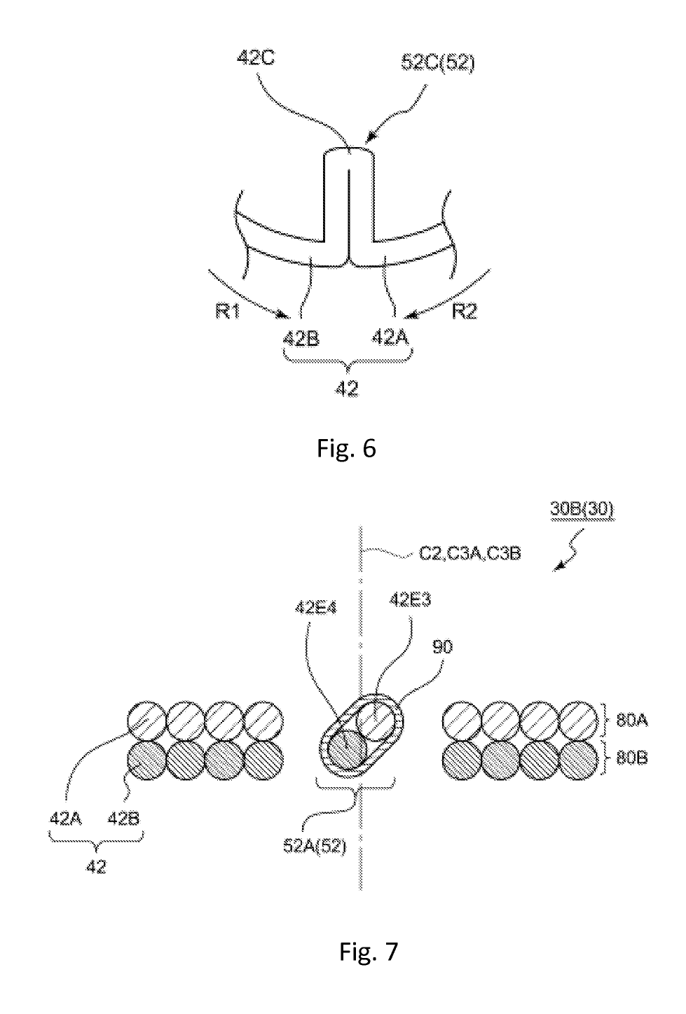

Yet further, as shown in FIG. 6, a part near the approximate intermediate point 42C of the conduction wire 42 is bent into two and bunched together so as to make such part function as a tap wire 52C (52). In this case, first of all, the conducting wire 42 is bent at the approximate intermediate point 42C. Next, the conducting wire 42, which is formed by bending and bunching together, is pulled out toward a direction substantially perpendicular to the winding directions R1 and R2 of the first and second coils 80A and 80B. A part that is pulled out is used as the tap wire 52C.

FIG. 7 is a cross section view of the power transmission coil 30B (30) shown in FIG. 3A. Specifically, FIG. 7 is a sectional view that shows an embodiment of a cross section taken along line A-A of the power transmission coil 30B (30) shown in FIG. 3A. As shown in FIG. 7, the power transmission coil 30B has a structure in which the first coil 80A and the second coil 80B are stacked each other with respect to the central axis C2. Therefore, the power transmission coil 30B can be made in a compact shape in a direction along a plane perpendicular to the central axis C2. However, because the first coil 80A and the second coil 80B are stacked with each other with respect to the central axis C2, there is a difference of one wire-thickness of the conducting wire 42 between a distance D1, which corresponds to a gap between the first coil 80A and the power receiving coil 20, and a distance D2, which corresponds to a gap between the second coil 80B and the power receiving coil 20. Therefore, there are some differences of the coupling coefficients between the first coil 80A and the power receiving coil 20 and between the second coil 80B and the power receiving coil 20. These differences of the coupling coefficients are based on the differences between the distances D1 and D2.

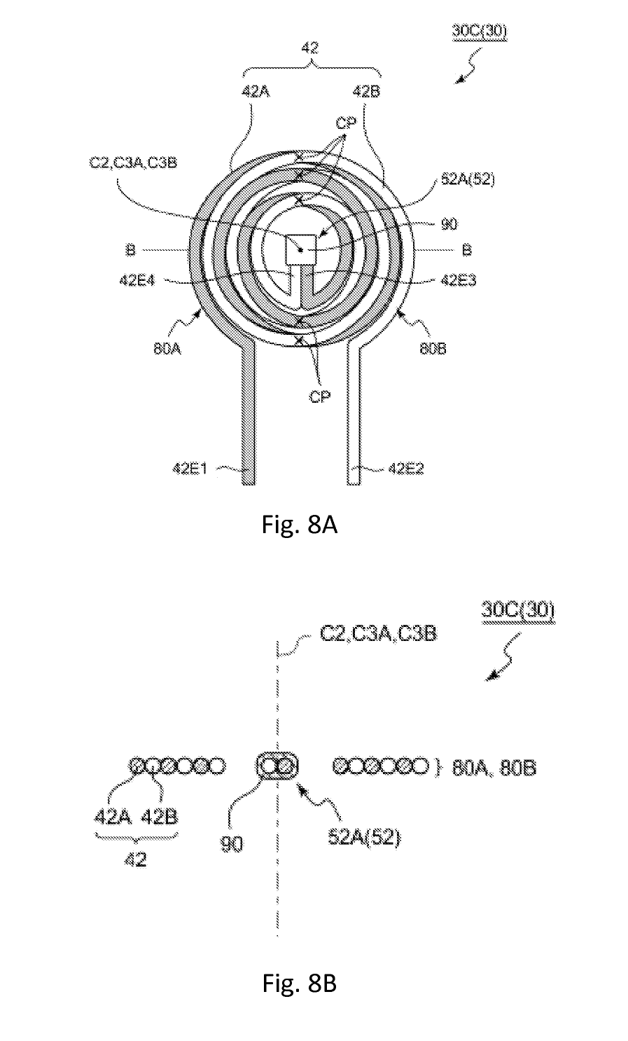

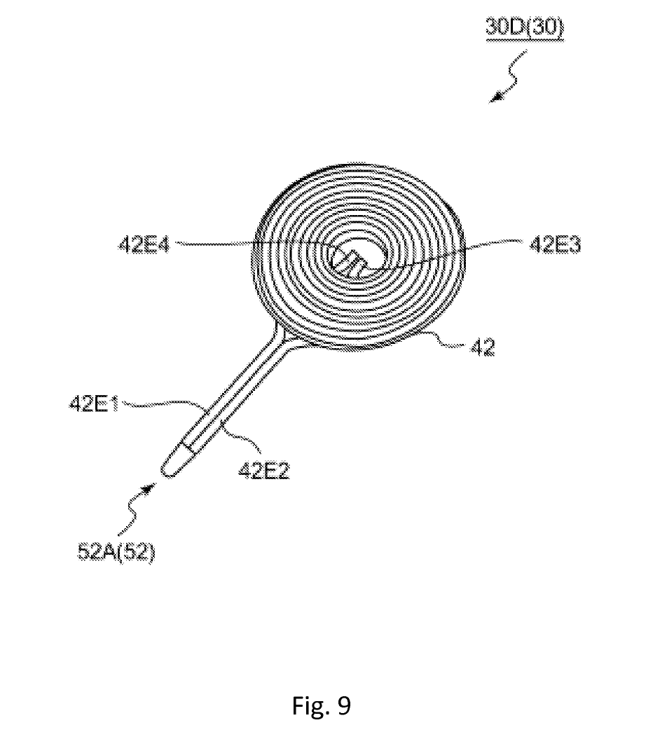

To solve the above issues above, it is preferred that the first coil 80A and the second coil 80B be substantially located in the same plane. FIGS. 8A and 8B are schematic views that show a modification of the power transmission coil 30B shown in FIGS. 3A and 7. Specifically, FIG. 8A is a plan view of a power transmission coil 30C (30). FIG. 8B is a sectional view of the power transmission coil taken along line B-B in FIG. 8A. The power transmission coil 30C shown in FIGS. 8A and 8B has the first coil 80A and the second coil 80B that are shown in FIGS. 3B and 3C. Further, the conducting wire 42 is shown darkened and the number of windings of the conducting wire 42 is less in FIGS. 8A and 8B for easy understandings.

As shown in FIG. 8B, the conducting wire 42A that configures the first coil 80A and the conducting wire 42B that configures the second coil 80B are located in order to make one layer on the same plane. However, because the winding direction R1 of the conducting wire 42A and the winding direction R2 of the conducting wire 42B are opposite to each other, the conducting wire 42A and the conducting wire 42B alternatively cross each other about every semicircle of windings. In other words, the conducting wire 42A is alternatively at a top and a bottom with respect to the conducting wire 42B at crossover points CP. Thus, near the crossover points CP where the conducting wires 42A and 42B cross each other, the conducting wires 42A and 42B are completely stacked with two layers along the central axis C2. Therefore, except for the vicinity of the stacked parts at the crossover points CP, the conducting wire 42A that configures the first coil 80A and the conducting wire 42B that configures the second coil 80B are located on the same plane. Namely, the first coil 80A and the second coil 80B are substantially located on the same plane with respect to almost an entirety thereof.

Therefore, in the power transmission coil 30C shown in FIGS. 8A and 8B, a difference between the distance D1, which corresponds to a gap between the first coil 80A and the power receiving coil 20, and the distance D2, which corresponds to a gap between the second coil 80B and the power receiving coil 20, becomes substantially zero (0). Therefore, in the power transmission coil 30C shown in FIGS. 8A and 8B, it is possible to substantially prevent differences of the coupling coefficients between the first coil 80A and the power receiving coil 20 and between the second coil 80B and the power receiving coil 20 from occurring due to the distance differences between the distance D1 and the distance D2.

Further, according to the embodiments shown in FIGS. 3A through 8B, the tap wire 52 (52A, 52B, 52C) (the center tap) is provided at a location corresponding to the wire ends 42E3 and 42E4 that are internal ends of the internal circumference side of the conducting wire 42A that configures the first coil 80A and the conducting wire 42B that configures the second coil 80B, respectively. However, the tap wire 52 (the center tap) can also be provided at a location corresponding to the wire ends 42E1 and 42E2 that are external ends of the external circumference side of the conducting wire 42A that configures the first coil 80A and the conducting wire 42B that configures the second coil 80B, respectively.

FIG. 9 is a schematic view that shows another modification of the power transmission coil 30B shown in FIGS. 3A and 7. Here, FIG. 9 shows an external appearance of a power transmission coil 30D (30). The power transmission coil 30D shown in FIG. 9 basically has the same configuration as the power transmission coil 30B shown in FIG. 3. However, there is a difference regarding a location of the tap wire 52A (center tap). Specifically, the power transmission coil 30D shown in FIG. 9 has the tap wire 52A (the center tap) at the external circumference side, not at the internal circumference side.

As discussed above, the power transmission coil 30D is configured with the first and second coils 80A and 80B. Therefore, when the tap wire 52A is a winding start point, the first coil 80A is configured with the conducting wire 42A that is circularly extending from the tap wire 52A by winding in a direction from the external circumference side to the internal circumference side. If the above configuration is applied to the embodiment shown in FIG. 3B, the following configuration can be used: When the wire end 42E1 of the conducting wire 42A that is a part of the tap wire 52A is a winding start point, the first coil 80A is configured with the conducting wire 42A that is circularly extending from the wire end 42E1 by winding in the direction R2 (opposite to the direction R1) from the external circumference side to the internal circumference side. When the tap wire 52A is a winding start point, the second coil 80B is configured with the conducting wire 42B that is circularly extending from the tap wire 52A by winding in an opposite direction from the external circumference side to the internal circumference side. If the above configuration is applied to the embodiment shown in FIG. 3C, the following configuration can be used: When the wire end 42E2 of the conducting wire 42B that is a part of the tap wire 52A is a winding start point, the second coil 80B is configured with the conducting wire 42B that is circularly extending from the wire end 42E2 by winding in the direction R1 (opposite to the direction R2) from the external circumference side to the internal circumference side. Note that the location of the tap wire 52A shown in FIG. 9 is different from the tap wires 52B and 52C shown in FIGS. 5 and 6 because the tap wire 52A shown in FIG. 9 is located at the external circumference side and the tap wires 52B and 52C shown in FIGS. 5 and 6 are located at the internal circumference side. However, the tap wires 52B and 52C shown in FIGS. 5 and 6 and discussed in the embodiments can be used as the tap wire 52A shown in FIG. 9.

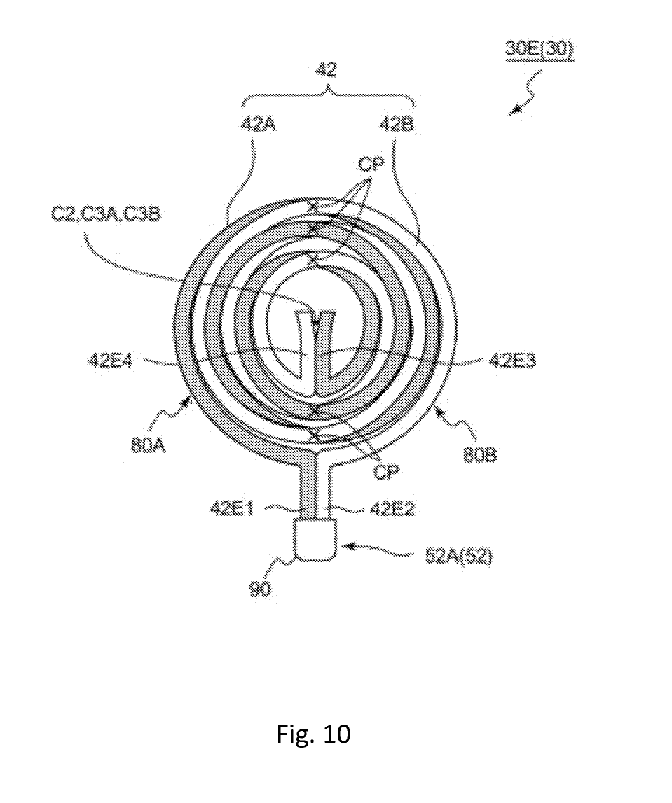

Further, FIG. 10 is a plan view that shows a modification of the power transmission coil 30C shown in FIG. 8A. A power transmission coil 30E (30) shown in FIG. 10 basically has the same configuration as the power transmission coil 30C shown in FIG. 8A. However, there is a difference about a location of the tap wire 52A (center tap). Specifically, the power transmission coil 30E shown in FIG. 10 has the tap wire 52A (the center tap) at the external circumference side, not at the internal circumference side.

With respect to the power transmission coils according to the embodiments of the present invention discussed above, either or both of the first coil and the second coil can be configured with a litz wire that is explained below.

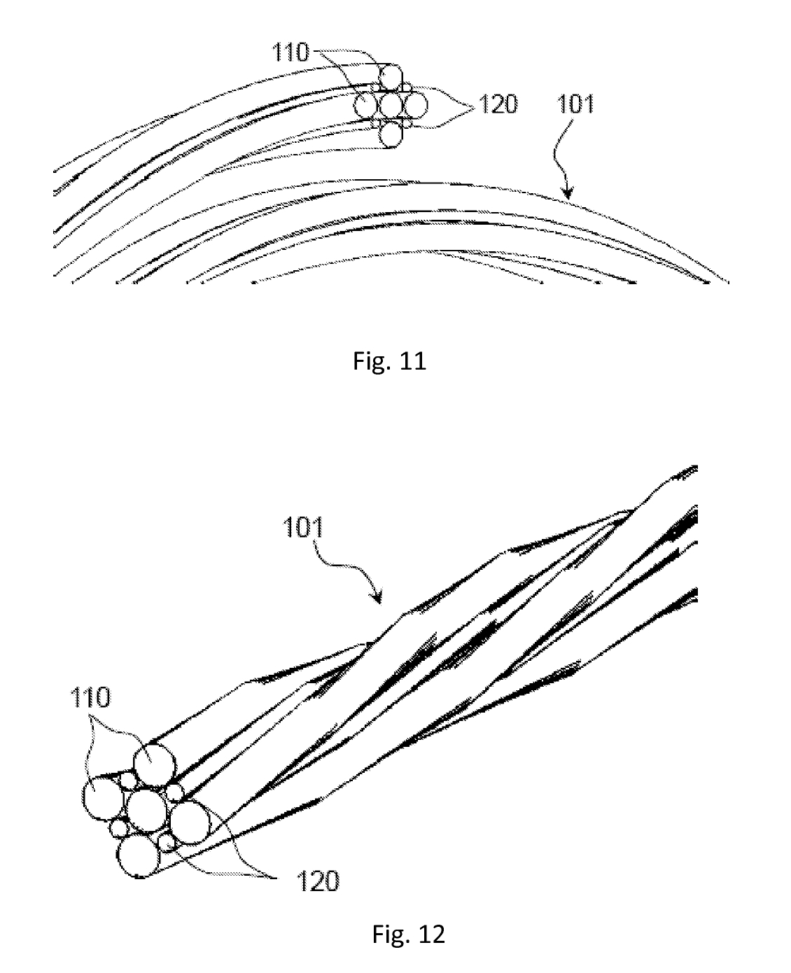

FIG. 11 is a schematic view that shows a configuration of a litz wire 101 according to an embodiment of the present invention. FIG. 12 is an enlarged perspective view that shows a condition in which the litz wire 101 shown in FIG. 11 is linearly extended. The litz wire 101 is composed by twisting or interwinding a plurality of large diameter strands 110 and a plurality of small diameter strands 120 in which a diameter is smaller than a diameter of the large diameter strands 110 in a spiral state. When the litz wire 101 is wound to form a power transmission coil 30, high frequency electric power, for instance 50-500 kHz, can be transmitted.

Further, the large diameter strand 110 and the small diameter strand 120 are both insulated wires that are configured with a copper conducting wire on which an insulating layer covers. A diameter of the large diameter strand 110 is, for instance, 0.10-0.40 mm. On the other hand, a diameter of the small diameter strand 120 is, for instance, 0.04-0.10 mm.

Further, when the diameters of the large diameter and small diameter strands 110 and 120 are discussed in embodiments, the diameters mean an entire thickness of the large diameter and small diameter strands 110 and 120. In other words, the diameters include a thickness of the insulating layer. The thickness of the insulating layer is, for instance, an order of several micro meters (μm). The thickness of the insulating layer slightly increases when the diameter of each of the large diameter and small diameter strands 110 and 120 increases. However, the thickness of the insulating layer is not proportional to the diameter of each of the large diameter and small diameter strands 110 and 120.

According to the embodiment shown in FIG. 11, five large diameter strands 110 and four small diameter strands 120 are twisted or interwound so as to be dense with one another. Namely, the litz wire 101 is formed by filling spaces among the large diameter strands 110 with the small diameter strands 120 and structured in order to configure the strands with high efficiency on a cross section of the litz wire 101. However, in reality, the large diameter and small diameter strands 110 and 120 are twisted and interwound in a slightly disordered state to some extent as compared with the state shown in FIG. 12. In the following explanation, the state explained above is included.

The litz wire 101 is composed by interwinding each of the strands 110 and 120 to be in a spiral state. As a result, each of the strands 110 and 120 is evenly crossed to magnetic flux when the power transmission coil 30 is formed by winding the litz wire 101.

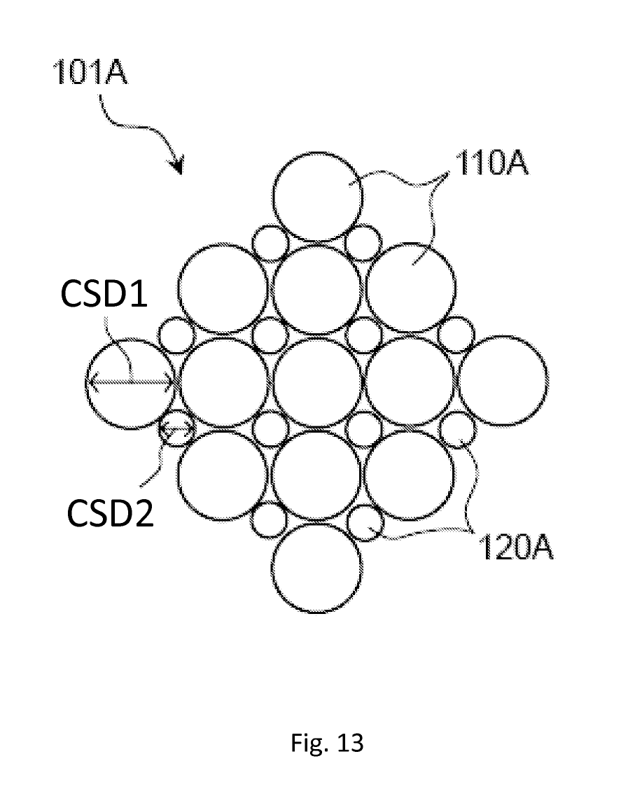

FIG. 13 is a schematic view that shows an end surface of a litz wire 101A in which the number of strands are increased to more than that in the litz wire 101 shown in FIG. 11. The basic structure of the litz wire 101A is almost the same as the litz wire 101 explained above. Further, the litz wire 101A is formed by twisting or interwinding large diameter strands 110A and small diameter strands 120A to be in a spiral state. The litz wire 101A uses 13 large diameter strands 110A and 12 small diameter strands 120A. As for the difference, the litz wire 101A uses more strands 110A and 120A than the litz wire 101.

As explained above, the number of the litz wires 101 and 101A according to the embodiments of the present invention can be set to a desired number of strands 110, 110A, 120, 120A depending on ratios of the large diameter strands 110 and 110A and of the small diameter strands 120 and 120A according to purposes and prescribed properties within a desired range as explained later.

In these litz wires 101, according to current frequency increases, such as from 10 kHz to 50 kHz, that flows in each of the strand 110, 110A, 120 and 120A (hereinafter, 110 and 120), the current flows around the surface layer of each of the strands 110 and 120 and becomes difficult to flow inside due to a Skin effect. Therefore, when the sum of total cross sections of all the strands 110 and 120 becomes equal, as the number of strands 110 and 120 is fewer, the litz wire 101 shows a higher resistance value. On the other hand, when the number of strands 110 and 120 becomes too many, a percentage of the cross section of the insulating layer on the circumference surface of the strands 110 and 120 increases. As a result, because an external size of a coil for supplying electric power becomes large, the mounting space for the coil cannot be efficiency improved. In addition, because an occupied space of conducting wires of the litz wire 101, 101A cannot be efficiently improved, a direct current resistance (DCR) increases.

In consideration of the above facts, the litz wire 101 according to the embodiments of the present invention is set in order to satisfy at least one factor that is explained as follows: a range of a preferred number ratio P of both large diameter and small diameter strands 110, 120, a range of a preferred cross section ratio Q of both large diameter and small diameter strands 110, 120 and a range of a preferred total cross section ratio R of both large diameter and small diameter strands 110, 120.

Range of Number Ratio of Both Strands

The range of a preferred number ratio of both strands 110, 120 is shown as Formula 1 below by using a number ratio P of the number of the small diameter strands 120 to the number of the large diameter strands 110, i.e., (the small diameter strands 120)/(the large diameter strands 110).

0.4≦P≦1.2 (Formula 1)

When a value of the number ratio P is lower than a lower limit (0.4) in Formula 1 shown above, there is substantially no effect for avoiding an increase of a resistance value by reducing the influence of the above Skin effect because the number ratio P is small and the number of the small diameter strands is small. On the other hand, when a value of the number ratio P is higher than an upper limit (1.2) in Formula 1 shown above, a percentage of the cross section of the insulating layer on the circumference surface of the strands 110, 120 increases as explained above. As a result, because an external size of the power transmission coil 30 becomes large, the mounting space for the power transmission coil 30 cannot be efficiency improved. In addition, because an occupied space of conducting wires of the litz wire 101, 101A cannot be efficiently improved, a direct current resistance (DCR) increases.

In other words, when the number ratio P satisfies the above Formula 1, the diameter of the litz wires 101 and 101A that supplies/transmits a high frequency electric power of 50-500 kHz can be smaller. A power transmission coil that has such a litz wire can reduce the loss of a current, decrease an occupied space of conducting wires, and decrease a direct current resistance (DCR).

Further, when Formula 1′ below is used instead of Formula 1 above, the effect explained above can be improved.

0.5≦P≦1.0 (Formula 1′)

Specifically, according to the embodiment shown in FIG. 12, five large diameter strands 110 and four small diameter strands 120 are used. Therefore, the number ratio P is 4/5 that corresponds to 0.8. Similarly, according to the embodiment shown in FIG. 13, 13 large diameter strands 110A and 12 small diameter strands 120A are used. Therefore, the number ratio P is 12/13 that corresponds to about 0.92. Both number ratios P satisfy Formulas 1 and 1′.

Range of Cross Section Ratio of Both Strands

A range of a preferred cross section ratio of both strands 110, 120 is shown as Formula 2 below by using a cross section ratio Q of a cross section of the small diameter strand 120 and 120A to a cross section of the large diameter strand 110 and 110A, i.e., (the small diameter strands 120)/(the large diameter strands 110).

0.01≦Q≦0.30 (Formula 2)

When a value of the cross section ratio Q is lower than a lower limit (0.01) in Formula 2 shown above, there is substantially no effect for avoiding an increase of a resistance value by reducing the influence of the above Skin effect because the cross section ratio Q is small and a relative cross section of the small diameter strand 120 and 120A is small. On the other hand, when a value of the cross section ratio Q is higher than an upper limit (0.30) in Formula 2 shown above, a percentage of the cross section of the insulating layer on the circumference surface of the strand increases if the reason for exceeding the upper limit is based on increasing the number of the small diameter strands 120 and 120A. As a result, because an external size of the power transmission coil 30 becomes large, the mounting space for the power transmission coil 30 cannot be efficiency improved. In addition, because an occupied space of conducting wires of the litz wire 101, 101A cannot be efficiently improved, a direct current resistance (DCR) increases. On the other hand, if the reason for exceeding the upper limit is based on increasing each cross section of the small diameter strands 120 and 120A, there is substantially no effect for avoiding an increase of a resistance value by reducing the influence of the above Skin effect. Note that increasing each cross section of the small diameter strands 120 and 120A means that a diameter CSD2 of the small diameter strand 120 and 120A far exceeds a half of a diameter CSD1 of the large diameter strand 110 and 110A.

In other words, when the cross section ratio Q satisfies the above Formula 2, the diameter of the litz wires 101 and 101A that supplies/transmits a high frequency electric power of 50-500 kHz can be smaller. A power transmission coil that has such a litz wire can reduce the loss of a current, decrease an occupied space of conducting wires, and decrease a direct current resistance (DCR).

Further, when Formula 2′ below is used instead of Formula 2 above, the effect explained above can be improved.

0.02≦Q≦0.25 (Formula 2′)

Specifically, according to the embodiment shown in FIG. 13, when the diameter CSD1 of the large diameter strand 110A is 0.2 mm and the diameter CSD2 of the small diameter strand 120A is 0.06 mm, CSD2/CSD1 is equal to 0.06/0.2 and corresponds to 0.3. In this case, the cross section ratio Q of a cross section of each small diameter strand 120 and 120A to a cross section of each large diameter strand 110 and 110A is 0.09. Note that 0.09 is obtained by either (0.3*0.3) or [(0.03*0.03*3.14)/(0.1*0.1*3.14)]. Therefore, this cross section ratio 0.09 satisfies Formulas 2 and 2′ discussed above.

Range of Total Cross Section Ratio of Both Strands

Further, a range of a preferred total cross section ratio of both strands 110, 120 is shown as Formula 3 below by using a total cross section ratio R of a total cross section of the small diameter strands 120 and 120A to a total cross section of the large diameter strands 110 and 110A, i.e., (the small diameter strands 120)/(the large diameter strands 110).

0.004≦R≦0.360 (Formula 3)

Formula 3 above is close to a range that is defined by multiplying Formula 1 and Formula 2. When a value of the total cross section ratio R is lower than a lower limit (0.004) in Formula 3 shown above, there is substantially no effect for avoiding an increase of a resistance value by reducing the influence of the above Skin effect because the total cross section ratio R is small and a relative total cross section of the small diameter strand 120 and 120A is small. On the other hand, when a value of the total cross section ratio R is higher than an upper limit (0.360) in Formula 3 shown above, a percentage of the cross section of the insulating layer on the circumference surface of the strand increases if the reason for exceeding the upper limit is based on increasing the number of the small diameter strands 120 and 120A. As a result, because an external size of the power transmission coil 30 becomes large, the mounting space for the power transmission coil 30 cannot be efficiency improved. In addition, because an occupied space of conducting wires of the litz wire 101, 101A cannot be efficiently improved, a direct current resistance (DCR) increases. On the other hand, if the reason for exceeding the upper limit is based on increasing each cross section of the small diameter strands 120 and 120A, there is substantially no effect for avoiding an increase of a resistance value by reducing the influence of the above Skin effect. Note that increasing each cross section of the small diameter strands 120 and 120A means that a diameter CSD2 of the small diameter strand 120 and 120A far exceeds a half of a diameter CSD1 of the large diameter strand 110 and 110A.

In other words, when the total cross section ratio R satisfies the above Formula 3, the diameter of the litz wires 101 and 101A that supplies/transmits a high frequency electric power of 50-500 kHz can be smaller. A power transmission coil that has such the litz wire can reduce the loss of a current, decrease an occupied space of conducting wires, and decrease a direct current resistance (DCR).

Further, when Formula 3′ below is used instead of Formula 3 above, the effect explained above can be improved.

0.010≦R≦0.250 (Formula 3′)

Specifically, according to the embodiment shown in FIG. 13, when the number of the large diameter strands 110A is 13, the diameter CSD1 is 0.20 mm, the number of the small strands 120A is 12 and the diameter CSD2 is 0.06 mm, (CSD2/CSD1)² corresponds to (0.06/0.20)² and corresponds to 0.09. In this case, the total cross section ratio R of the total cross section of the small diameter strands 120A to the total cross section of the large diameter strands 110A is 0.09×(12/13)=0.083. Therefore, this total cross section ratio 0.083 satisfies Formulas 3 and 3′ discussed above.

As discussed above, the litz wire according to the embodiments of the present invention is explained. However, the litz wire is not limited to the above embodiments. It will be apparent that the same may be varied in many ways.

For instance, according to the embodiments of the present invention, all of the large diameter strands 110 and 110A and the small diameter strands 120 and 120A are insulated wires on which an insulating layer covers. However, the small diameter strands 120 and 120A can be non-insulated wires without an insulating layer. Thus, the litz wires can be configured by twisting or interwinding the small diameter and large diameter strands in which the small diameter strands do not touch with each other by surrounding each small diameter strand with a plurality of the large diameter strands.

Further, each value of the number ratio P for the both strands 110 and 120 above, the cross section ratio Q for the both strands 110 and 120 above and the total cross section ratio R for the both strands 110 and 120 above can be out of the range of the above values described as Formulas 1, 2 and 3. Further, those preferred values can suitably be set. However, as explained above, it is preferred that at least one Formula among the Formulas 1, 2 and 3 is satisfied.

The contactless power supply system 10 according to the embodiments of the present invention is not especially restricted regarding its applications. However, it is preferred that it is used for supplying electric power to portable electronic devices. In this case, the power receiving coil 20 is installed in the portable electronic devices and the power transmission coil 30 is installed in a battery charger. Here, as the portable electronic devices, for instance, cellular phones, smart phones, personal digital assistant devices (PDAs), IC recorders, portable music players (MP3 players) and notebook personal computers can be mentioned.

Further, when the contactless power supply system 10 according to the embodiments of the present invention is used for supplying electric power to portable electronic devices, merits and advantages can be obtained as explained below as compared with the conventional method for supplying electric power by using the conventional connectors.

Users of the portable electronic devices can be released from troubles in which the portable electronic devices need to be connected to chargers or power sources for being supplied electric power and in which the users have to keep the connectors when electric power is not supplied.

Risk that the connectors get damaged and get unable to transmit electric power by repeated usages can be decreased.

Although users own a plurality of portable electronic devices, users can be released from the trouble in which the users do not need to manage and maintain a plurality of chargers corresponding to each portable electronic device.

The contactless power supply system and the power transmission coil for the contactless power supply system being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A contactless power supply system, comprising:
a power transmission coil;
a power receiving coil; and
a center tap that is provided at the power transmission coil.

2. The contactless power supply system according to claim 1, wherein
the power transmission coil has a first coil and a second coil,
the first coil is configured with a first conducting wire that circularly extends from the center tap by winding in a first direction from a first internal circumference side to a first external circumference side,
the second coil is configured with a second conducting wire that circularly extends from the center tap by winding in a second direction, which is opposite to the first direction, from a second internal circumference side to a second external circumference side, and
a first number of windings of the first coil is approximately the same as a second number of windings of the second coil, a first length and a first thickness of the first conducting wire are approximately the same as a second length and a second thickness of the second conducting wire, respectively.

3. The contactless power supply system according to claim 1, wherein
the power transmission coil has a first coil and a second coil,
the first coil is configured with a first conducting wire that circularly extends from the center tap by winding in a first direction from a first external circumference side to a first internal circumference side,
the second coil is configured with a second conducting wire that circularly extends from the center tap by winding in a second direction, which is opposite to the first direction, from a second external circumference side to a second internal circumference side, and
a first number of windings of the first coil is approximately the same as a second number of windings of the second coil, a first length and a first thickness of the first conducting wire are approximately the same as a second length and a second thickness of the second conducting wire, respectively.

4. The contactless power supply system according to claim 1, wherein
the power transmission coil has a first coil and a second coil,
the first coil is configured with a first conducting wire that circularly extends from the center tap by winding in a first direction from one of a first internal circumference side and a first external circumference side to the other of the first internal circumference side and the first external circumference side,
the second coil is configured with a second conducting wire that circularly extends from the center tap by winding in a second direction, which is opposite to the first direction, from one of a second internal circumference side and a second external circumference side to the other of the second internal circumference side and the second external circumference side, and
a first number of windings of the first coil is approximately the same as a second number of windings of the second coil, a first length and a first thickness of the first conducting wire are approximately the same as a second length and a second thickness of the second conducting wire, respectively.

5. The contactless power supply system according to claim 4, wherein
the first coil and the second coil are substantially located in the same plane.

6. The contactless power supply system according to claim 5, further comprises:
a portable electronic device; and
a charger, wherein
the power receiving coil is mounted in the portable electronic device, and
the power transmission coil is mounted in the charger.

7. The contactless power supply system according to claim 4,
the first wire and the second wire are litz wires.

8. The contactless power supply system according to claim 7, wherein
each litz wire has a plurality of first strands and a plurality of second strands that are intertwined with each other in a spiral, a first diameter of each of the plurality of first strands is larger than a second diameter of each of the plurality of second strands, and
a high frequency electric power between 50 kHz and 500 kHz is supplied through the litz wires.

9. The contactless power supply system according to claim 8, wherein
a ratio of a first number of the plurality of first strands to a second number of the plurality of second strands is equal to or more than 0.4 and equal to or less than 1.0.

10. The contactless power supply system according to claim 8, wherein
a ratio of a first cross section area of one of the plurality of first strands to a second cross section area of one of the plurality of second strands is equal to or more than 0.01 and equal to or less than 0.25.

11. The contactless power supply system according to claim 8, wherein
a ratio of a first sum of first cross sections of the plurality of first strands to a second sum of second cross sections of the plurality of second strands is equal to or more than 0.004 and equal to or less than 0.25.

12. A power transmission coil of a contactless power supply system, comprising:
a litz wire that has a plurality of strands; and
a center tap that is provided at the litz wire.
